(19) United States
(12) Patent Application Publication
(10) Pub. No.: US 2010/0122336 A1
(43) Pub. Date: May 13, 2010

(54) METHOD AND APPARATUS FOR TWO-WAY TRANSMISSION OF MEDICAL DATA

(76) Inventors: Elias Hunt, Cornish, NH (US); David T. Chen, Wrentham, MA (US); M. Weston Chapman, Hanover, NH (US)

Correspondence Address: Mark J. Pandiscio;Pandiscio & Pandiscio, P.C., 470 Totten Pond Road, Waltham, MA, 02451, US

(21) Appl. No.: 12/271,636

(22) Filed: Nov. 14, 2008

Related U.S. Application Data
(63) Continuation-in-part of application No. 10/994,730, filed on Nov. 22, 2004.
Application No. 10/994,730 is a continuation-in-part of application No. 11/318,114, filed on Dec. 23, 2005.
(60) Provisional application No. 61/003,003, filed on Nov. 14, 2007.

(51) Int. Cl. H04L 9/00; H04L 9/32; G06F 15/16

(52) U.S. Cl. 726/11

(57) ABSTRACT

The present invention provides for a secure, two-way transmission of medical data over the Internet and through the hospital's firewall using push and pull mechanisms. More particularly, the present invention utilizes standard SSH technology and the rsync and scp protocols to enable secure, cost-effective data transmission over the Internet. The hospital firewall is traversed through the use of an agent located behind the hospital's firewall. The agent utilizes a push mechanism to push the raw scan data through the firewall and over the Internet to the outside third party; and the agent uses a pull mechanism to reach through the firewall and over the Internet to retrieve the data processed by the outside third party. In other words, the present invention transfers data from the hospital to the third party by initiating a data push mechanism from behind the hospital firewall; and transfers the processed data from the outside third party back into the hospital by initiating a data pull mechanism from behind the hospital firewall. The aforementioned agent acts as a broker for the foregoing data transmission and also encodes how the data should be handled once it is received on the hospital side.

### REFERENCE TO PENDING PRIOR PATENT APPLICATIONS

This patent application:

(1) is a continuation-in-part of pending prior U.S. patent application Ser. No. 10/994,730, filed Nov. 22, 2004 by Dennis O′Connor et al. for METHOD AND APPARATUS FOR TWO-WAY TRANSMISSION OF MEDICAL DATA (Attorney's Docket No. MMS-28);

(2) is a continuation-in-part of pending prior U.S. patent application Ser. No. 11/318,114, filed Dec. 23, 2005 by David Chen et al. for METHOD AND APPARATUS FOR TWO-WAY TRANSMISSION OF MEDICAL DATA (Attorney's Docket No. MMS-35); and

(3) claims benefit of pending prior U.S. Provisional Patent Application Ser. No. 61/003,003, filed Nov. 14, 2007 by Elias Hunt et al. for EXPANDED DAC SYSTEM WITH SITE-TO-SITE TRANSFER AND IMAGE BLINDING COMPONENTS (Attorney's Docket No. MMS-38 PROV).

The three above-identified patent applications are hereby incorporated herein by reference.

### FIELD OF THE INVENTION

This invention relates to the two-way transmission of medical data in general, and more particularly to the HIPAA-compliant transfer of patient-specific image data between a healthcare provider and a third party.

### BACKGROUND OF THE INVENTION

The sharing of patient image data between healthcare providers (e.g., hospitals) and third parties (e.g., specialized imaging services such as M2S, Inc. (formerly Medical Metrx Solutions) of West Lebanon, N.H.) presents a myriad of challenges. These challenges include privacy, expense and accessibility, among others.

In 1996, President Clinton signed the Health Insurance Portability and Accountability Act (HIPAA). Among other things, this law (i) ensures the continuity of healthcare coverage for individuals changing jobs; (ii) includes a provision that impacts the management of health information; (iii) seeks to simplify the administration of health insurance; and (iv) aims to combat waste, fraud and abuse in health insurance and healthcare.

The Department of Health and Human Services has issued various regulations to implement these new requirements. These regulations impact all healthcare organizations that electronically create, store and/or transmit healthcare data. Among other things, HIPAA requires the secure storage and transmission of electronic healthcare data.

Setting up Virtual Private Networks (VPNs) or running point-to-point T1 lines can provide the necessary secure transmission of electronic healthcare data. However, VPNs and T1 lines can be cost prohibitive in many situations.

Alternatively, the so-called secure shell (SSH) technology and rsync protocol can be used to provide a suite of network connectivity tools which enable secure transmission of electronic healthcare data by creating a minimal subset of a many-to-one virtual network running over the public Internet.

In addition to the foregoing, medical institutions (e.g., hospitals) typically implement firewalls to limit outside access to their internal computer networks. Among other things, and of particular significance to the present invention, hospital firewalls will typically block outside attempts to access any medical data on their internal radiology networks.

Unfortunately, in many situations it can be important for a healthcare provider (e.g., a hospital) to share data with an outside third party (e.g., a service provider). By way of example, and of particular application to the present invention, it may be desirable to pass raw scan data from the hospital to an outside imaging service for specialized processing and return. Thus, for example, CT scan data may need to be transmitted from a hospital to M2S, Inc. (formerly Medical Metrx Solutions) of West Lebanon, N.H. (M2S, formerly MMS), where that CT scan data is converted into patient-specific computer models and then returned to the hospital for viewing by medical personnel. In circumstances such as these, the aforementioned security systems for storing and transmitting electronic healthcare data can impede the electronic transfer of the data.

### SUMMARY OF THE INVENTION

The present invention provides for a secure, two-way transmission of medical data over the Internet and through the hospital's firewall using push and pull mechanisms. More particularly, the present invention utilizes standard SSH technology and the rsync and scp (secure copy) protocols to enable secure, cost-effective data transmission over the Internet. The hospital firewall is traversed through the use of an agent located behind the hospital's firewall. The agent utilizes a push mechanism to push the raw scan data through the firewall and over the Internet to the outside third party; and the agent uses a pull mechanism to reach through the firewall and over the Internet to retrieve the data processed by the outside third party. In other words, the present invention transfers data from the hospital to the third party by initiating a data push mechanism from behind the hospital firewall; and transfers the processed data from the outside third party back into the hospital by initiating a data pull mechanism from behind the hospital firewall. The aforementioned agent acts as a broker for the foregoing data transmission and also encodes how the data should be handled once it is received on the hospital side.

In one preferred form of the invention, there is provided an agent for transmitting data between a first site and a second site, and between the first site and a third site, wherein the first site, the second site and the third site are connected to the Internet, and further wherein the first site is located behind a firewall;

the agent being located behind the firewall and being connected to the first site and to the Internet, the agent comprising first, second, third and fourth components;

the first component being configured for receiving raw data from the first site;

the second component being configured for pushing a verification query through the firewall and over the Internet to the second site;

the third component being configured for pulling a verification over the Internet and through the firewall from the second site; and

the fourth component being configured for, upon receipt of the verification, pushing the raw data through the firewall and over the Internet to the second site and the third site.

In another preferred form of the invention, there is provided an agent for transmitting data between a first site and a second site, wherein the first site and the second site are connected to the Internet, and further wherein the first site is located behind a firewall;

the agent being located behind the firewall and being connected to the first site and to the Internet, the agent comprising first, second, third and fourth components;

the first component being configured for receiving raw data from the first site;

the second component being configured for pushing a verification query through the firewall and over the Internet to the second site;

the third component being configured for pulling a verification over the Internet and through the firewall from the second site; and

the fourth component being configured for, upon receipt of the verification, pushing the raw data through the firewall and over the Internet to the second site;

and further wherein the fourth component is configured to anonymize the raw data prior to pushing the raw data through the firewall and over the Internet to the second site.

In another preferred form of the invention, there is provided a system comprising:

a first site, a second site and a third site, wherein the first site, the second site and the third site are connected to the Internet, and further wherein the first site is located behind a firewall;

an agent for transmitting data between the first site, the second site and the third site, the agent being located behind the firewall and being connected to the first site and to the Internet, the agent comprising first, second, third and fourth components;

the first component being configured for receiving raw data from the first site;

the second component being configured for pushing a verification query through the firewall and over the Internet to the second site;

the third component being configured for pulling a verification over the Internet and through the firewall from the second site; and

the fourth component being configured for, upon receipt of the verification, pushing the raw data through the firewall and over the Internet to the second site and the third site.

In another preferred form of the invention, there is provided a system comprising:

a first site and a second site, wherein the first site and the second site are connected to the Internet, and further wherein the first site is located behind a firewall;

an agent for transmitting data between the first site and the second site, the agent being located behind the firewall and being connected to the first site and to the Internet, the agent comprising first, second, third and fourth components;

the first component being configured for receiving raw data from the first site;

the second component being configured for pushing a verification query through the firewall and over the Internet to the second site;

the third component being configured for pulling a verification over the Internet and through the firewall from the second site; and

the fourth component being configured for, upon receipt of the verification, pushing the raw data through the firewall and over the Internet to the second site;

and further wherein the fourth component is configured to anonymize the raw data prior to pushing the raw data through the firewall and over the Internet to the second site.

In another preferred form of the invention, there is provided a method for transmitting data between a first site and a second site, and between the first site and a third site, wherein the first site, the second site and the third site are connected to the Internet, and further wherein the first site is located behind a firewall, comprising:

receiving data from the first site;

pushing a verification query through the firewall and over the Internet to the second site;

pulling a verification over the Internet and through the firewall from the second site; and

upon receipt of the verification, pushing data through the firewall and over the Internet to the second site and the third site.

In another preferred form of the invention, there is provided a method for transmitting data between a first site and a second site, wherein the first site and the second site are connected to the Internet, and further wherein the first site is located behind a firewall, comprising:

receiving data from the first site;

pushing a verification query through the firewall and over the Internet to the second site;

pulling a verification over the Internet and through the firewall from the second site; and

upon receipt of the verification, anonymizing the data and then pushing the data through the firewall and over the Internet to the second site.

### BRIEF DESCRIPTION OF THE DRAWINGS

These and other objects and features of the present invention will be more fully disclosed or rendered obvious by the following detailed description of the preferred embodiments of the invention, which is to be considered together with the accompanying drawings wherein like numbers refer to like parts, and further wherein:

FIG. 1 is a schematic view showing the transmission of DICOM data from the hospital to a third party and the retrieval of processed data from the third party back to the hospital;

FIG. 2 is a schematic view showing the transmission of DICOM data from the hospital to a third party and the retrieval of DICOM data from the third party back to the hospital;

FIG. 3 is a schematic view showing remote 3D imaging in accordance with the present invention;

FIG. 4 is a schematic view showing an expanded form of the DAC system having order verification;

FIGS. 5 and 6 are schematic views showing an expanded form of the DAC system having Site-to-Site transfer;

FIGS. 7-20 are screen displays illustrating various aspects of the expanded form of the DAC system having Site-to-Site transfer; and

FIGS. 21 and 22 are schematic views showing an expanded form of the DAC system having a coordinator-specified image header blinding component.

### DETAILED DESCRIPTION OF THE PREFERRED EMBODIMENTS

### DAC Pro

The Digital Imaging and Communications In Medicine (DICOM) Standard was established in 1992 and is the standard for exchanging medical images in a digital format. DICOM was initiated by the American College of Radiology to address the need for connectivity between imaging equipment.

In accordance with the present invention, there is provided the aforementioned agent, which is essentially a two-way transfer device comprising computer hardware and software for enabling the secure, cost-effective transmission of data (including DICOM data) through a hospital's firewall and across the Internet. For convenience, the aforementioned agent may hereinafter sometimes be referred to as “DAC Pro”, which is an acronym for the DICOM ArmorCar Pro™ product of M2S, Inc. (formerly Medical Metrx Solutions) of West Lebanon, N.H. (M2S, formerly MMS), which constitutes one preferred implementation of the present invention.

The DAC Pro is designed to allow the secure transfer of DICOM image data over regular Internet connections without using Virtual Private Networks. The DAC Pro preferably comes pre-configured to work on the hospital network behind the firewall, and contains all of the hardware and software necessary to (i) send data across the firewall and through the Internet to a third party (e.g., M2S) for 3D processing, and (ii) retrieve the processed data (e.g., 3D patient-specific studies) back through the Internet and across the firewall for use in surgical planning by medical professionals at the hospital. Once the DAC Pro retrieves the data from M2S, it is stored for 30 days on a hard drive of the DAC Pro. The DAC Pro is not designed for long-term data storage; it is integrated into the hospital network so that data can be stored in hospital systems for long-term storage. The DAC Pro preferably runs a customized version of the Red Hat Linux operating system and boots from a CD-ROM. Preferably, all of the system software runs from the CD-ROM, and no system software needs to run from the hard drive of the DAC Pro. By having all software run from the CD-ROM, the DAC Pro has added security and is easily upgraded.

The DAC Pro resides within the healthcare institution's firewall. It pushes medical data through the firewall and over the Internet to M2S (or other third party) and/or pulls medical data back over the Internet and back through the firewall. Significantly, the third party (e.g., M2S) never sends data directly to the DAC Pro. Thus, the remote healthcare institution's firewall requires little modification and data is easily secured through encryption.

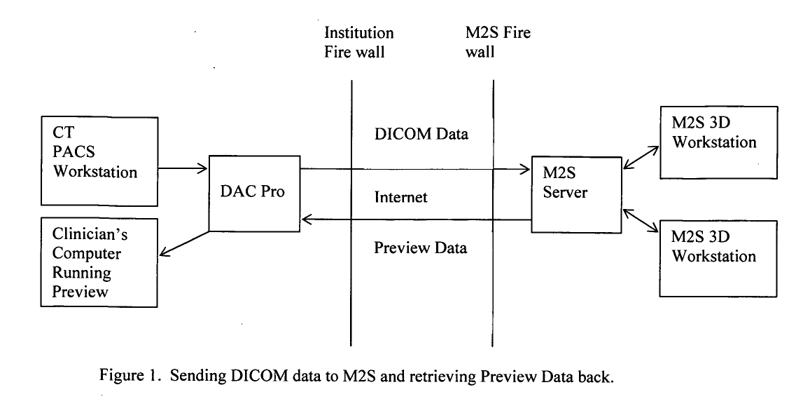

The DAC Pro can be used to transfer data in various formats. By way of example, the DAC Pro can be used to transfer DICOM data to M2S, and to retrieve 3D model data (e.g., M2S Preview® data) from M2S. See FIG. 1.

By using the DICOM standard for data transfer, the DAC Pro conforms with established radiology standards. The DICOM data is sent to the DAC Pro unit in the same manner as it would be transferred to another DICOM device within the hospital, e.g., a Picture Archiving System (PACS), a printer or a workstation. To reduce complexity, the DICOM protocol is not handled directly by the DAC Pro. Rather, protocol communications are forwarded securely by using 768-bit RSA public key authentication and 256-bit Advanced Encryption Standard (AES) data encryption through a secure shell (ssh) tunnel to a DICOM server at the third party, where the DICOM communication is handled. This ensures HIPPA compliance.

This outgoing data transmission is handled as a push through the firewall and over the Internet.

Once the DICOM data (e.g., the 2D CT slice data) arrives at M2S, M2S modeling technicians retrieve the data and create a patient-specific 3D Preview® model. Once modeling is complete, the patient-specific model is stored on a server at M2S. Preferably it is placed on the M2S server in an appropriate folder specifically set up for a particular hospital, and is preferably stored in an industry standard compressed format, e.g., single gzip'ed tar file. This single compressed file format is preferred, since it makes transfer times much faster than sending many uncompressed files.

The DAC Pro at the receiving hospital is in constant contact with the M2S server through the aforementioned ssh tunnel connection. Once the DAC Pro at the receiving hospital sees the completed study in its remote folder on the M2S server, it pulls the data back over the Internet and through the firewall to its local hard drive. At the hospital side the DAC Pro decrypts and decompresses the pulled data. The DAC Pro preferably runs a version of the Samba file server so that the data is easily available for viewing using the Preview® Planning software.

Significantly, the incoming data transmission is handled as a pull initiated from inside the firewall, which permits the data to be passed from M2S into the secure healthcare facility.

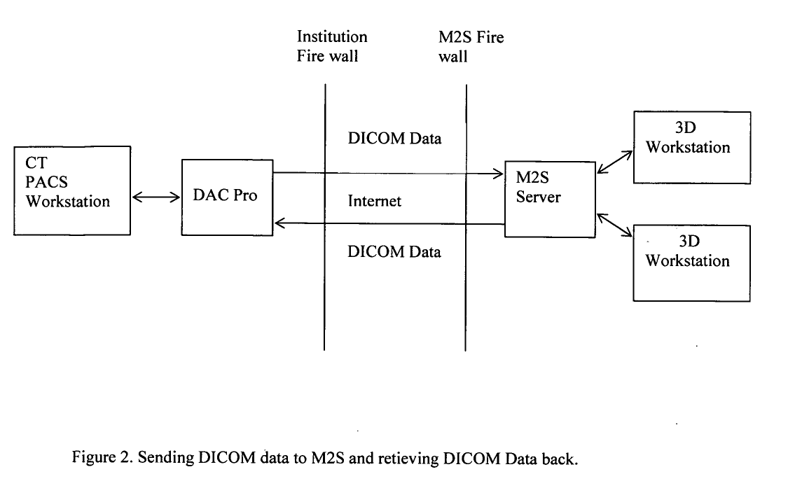

The DAC Pro can also be used to transfer DICOM data to M2S and to retrieve DICOM data back from M2S. See FIG. 2. By way of example but not limitation, the DAC Pro might send DICOM data to M2S for processing on 3D workstations using software other than the M2S Preview® software (e.g., software from Vital Images, Voxar, etc.) and then forward this processed DICOM data back to the institution's PACS system for viewing by radiologists and clinicians. More specifically, data is pushed to M2S with the same security measures described above. Technicians at M2S, using 3^{rd} party workstations, query the M2S DICOM server to retrieve the patient data. 3D image rendering is then effected by M2S technicians using the 3^{rd} party workstations. Once the 3D rendering is complete, the technicians need to return the processed DICOM data from their workstations to the sending institution. In this scenario, the data is first sent to the M2S DICOM server and placed in a separate directory based upon the receiving institutions DICOM AE TITLE (the AE Title is a unique identifier in the DICOM realm). The data in this directory is gzip'ed and tar'ed as described previously. However, this time the data has additional information pertaining to the receiving institution's PACS encoded in it. Again, the DAC Pro located inside the firewall at the remote site pulls the processed DICOM data from the M2S server once it sees data in its specific directory. This processed DICOM data is pulled over the Internet and through the firewall to the DAC Pro unit located at the remote site. With the encoded information and a trigger in the file name, the DAC Pro will know that this is DICOM data and not Preview® data. The DAC Pro will then use the AE Title, IP Address, and port number it retrieves and send the DICOM data to the hospital's PACS. Once on the hospital's PACS, the data is available to all clinicians who have access to the PACS.

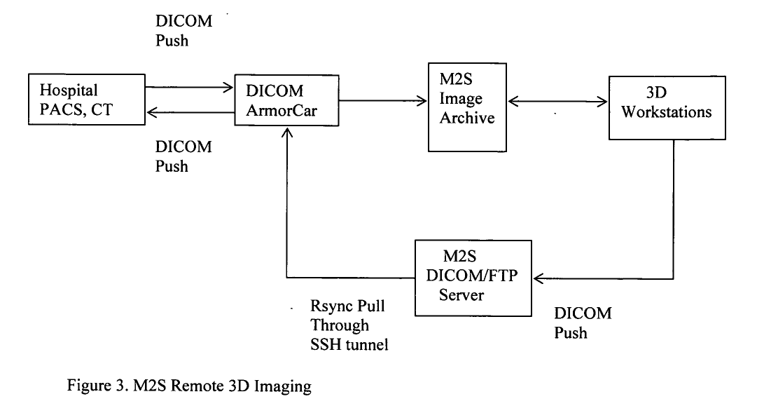

Looking next at FIG. 3, the remote hospital acts as an SCU to send data to the DAC Pro, which then forwards the data, using a push transfer, through the firewall and then across an ssh tunnel established over the Internet to the M2S server. Upon arriving at the M2S Image Archive server, the 3D workstations query the server for studies which need processing (preferably utilizing the DICOM general purpose worklist). Once the studies are complete, the 3D workstations act as an SCU to send the completed studies to the M2S outgoing DICOM server. This server receives the DICOM data and does the work of creating the gzip'ed tar file. The gzip'ed tar file is then transferred to an ftp “drop box” that is unique for the receiving institution. The DAC Pros located at their respective remote institutions are continually polling their respective “drop boxes” at the M2S server for data to retrieve. Once it is determined that there is data in the “drop box”, the DAC Pro pulls the data, using rsync or scp through a new ssh tunnel, to bring the data back over the Internet and through the firewall. Upon arriving at the DAC Pro, the DAC Pro uses the pre-configured information pertaining to that hospital's PACS (IP Address, port, and AE Title) to act as an SCU to push the data to the hospital's PACS. This is all completed using ssh connections over the Internet. All data is pushed to M2S, or pulled from M2S, from within the sending institution's firewall, keeping the data secure at all times.

The ssh tunnel can be established with an appropriate command such as:

```
/usr/bin/ssh -F ssh_config dicom.medicalmedia.com -q -N
where the file ssh_config points to the M2S Image
Archive.
Host *
          Port 22
          LocalForward 104 imagearchive.medicalmedia.com:104
          User mms_customer
```

### DAC 3

### Expanded System with Order Verification Component

### (i) Overview

In the foregoing description, there is described a Digital Imaging and Communications Standards in Medicine (DICOM) device of the type made by M2S, Inc. (formerly Medical Metrx Solutions) of West Lebanon, N.H. (M2S, formerly MMS). This device is sometimes referred to as “DAC Pro”. The DAC Pro device is essentially a two-way transfer device comprising computer hardware and software for enabling the secure, cost-effective transmission of data through a firewall (e.g., a hospital firewall) and across the Internet.

The DAC Pro device is designed to allow the secure transfer of DICOM image data over regular Internet connections without using Virtual Private Networks. The DAC Pro device is preferably pre-configured to work on the hospital network behind the firewall, and contains all the software necessary to: (i) send data across the firewall and through the Internet to M2S for 3D processing (i.e., “modeling”); and (ii) retrieve the processed data (e.g., 3D patient-specific “studies”) back through the Internet and across the firewall for use in surgical planning by medical professionals at the hospital. Once the DAC Pro device retrieves the data from M2S, the data is stored for a default term (e.g., 30 days, 35 days, etc.) on the hard drive of the DAC Pro device. The DAC Pro device is not designed for long-term storage; rather, the DAC Pro device is integrated into the hospital network so that data can be stored in hospital systems for long-term storage.

The DAC Pro device preferably runs a customized version of the Linux operating system (e.g., Fedora Linux or Red Hat Linux) and boots from a CD-ROM drive. The DAC Pro device resides inside the hospital's firewall. The DAC Pro device pushes medical data through the firewall and over the Internet to M2S and/or pulls medical data back over the Internet and back through the firewall. Significantly, M2S never sends data directly to the DAC Pro device. Rather, the DAC Pro device pulls data back into the hospital. Thus, the hospital's firewall remains intact and the hospital's data is secure.

The DAC Pro device can be used to transfer DICOM data to M2S, and to retrieve 3D model data (e.g., M2S Preview® data). By using the DICOM standard for data transfer, the DAC Pro device conforms with established radiology standards. The DICOM data is sent to the DAC Pro device in the same manner as that data would be transferred to another DICOM device located within the hospital, e.g., a Picture Archiving System (PACS), a printer, a workstation, etc.

To reduce complexity, the DICOM protocol is not handled directly by the DAC Pro device. Rather, protocol communications are securely forwarded from the DAC Pro device at the hospital to a DICOM server at M2S (where the DICOM communication is handled) by using, for example, a 768-bit RSA public key authentication and a 256-bit Advanced Encryption Standard (AES) data encryption procedure implemented through a secure shell (ssh) tunnel. This ensures HIPPA compliance.

The outgoing data transmission (i.e., from the DAC Pro device to M2S) is handled as a “push” through the hospital's firewall and over the Internet.

Once the DICOM data (e.g., the 2D slice data from the CT scanner) arrives at M2S, M2S modeling technicians retrieve the data and create a patient-specific 3D model. Once modeling is complete, the patient-specific 3D model is stored on a server at M2S. Preferably the 3D model is placed on the M2S server in an appropriate folder specifically set up for a particular hospital, and is preferably stored in an industry standard compressed format, e.g., in a single gzip'ed tar file. This single compressed file format is preferred, since it makes transfer times much faster than sending many uncompressed files.

The DAC Pro device (at the receiving hospital) is in constant contact with the M2S server through the aforementioned ssh tunnel connection. Once the DAC Pro device at the receiving hospital sees the completed study in its remote folder on the M2S server, the DAC Pro device “pulls” the data back over the Internet and through the firewall to its local hard drive. At the hospital side, the DAC Pro device decrypts and decompresses the data file pulled back across the firewall. The DAC Pro device runs a LINUX version of the SMB file server so that the data is easily available for viewing (i.e., using the M2S Preview® Planning software).

In accordance with the present invention, in an expanded version of the system, the system utilizes the same general configuration as the “DAC Pro” system discussed above. Significantly, however, the expanded version of the system (which will sometimes hereinafter be referred to as the “DAC 3” system) adds an order verification component to the system. This order verification component verifies a hospital order prior to the DAC 3 device pushing the DICOM data to the M2S server for processing. This order verification component allows M2S to verify that the DICOM data sent from hospital personnel to the DAC 3 device was in fact intended to be sent to M2S for modeling. Such verification can be advantageous for a variety of reasons, e.g., order confirmation and control, third party payer (e.g., insurer) considerations, patient privacy controls, cost controls, etc.

### (ii) The DAC 3 System

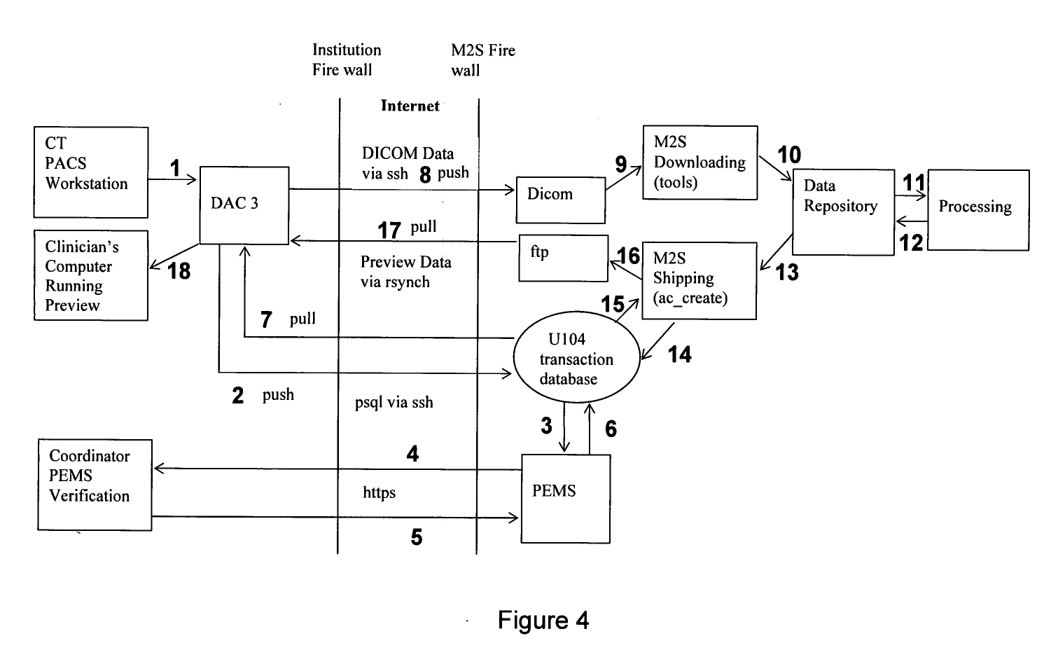

Looking now at FIG. 4, there is shown a schematic illustration of the DAC 3 system and its operation, which essentially consists of a series of dataflows between system elements.

Dataflow 1. The process is initiated when a user at a CT PACS workstation sends 2D CT scan data to the DAC 3 device located on the internal side of the firewall.

Dataflow 2. The DAC 3 device pushes a request for verification through the hospital firewall to the M2S U104 transaction database. This request for verification is pushed to the U104 transaction database as a psql communication through a secure shell (ssh) tunnel. The request for verification essentially advises M2S that the DAC 3 device is holding 2D scan data and requires verification that this 2D scan data should be sent to M2S for modeling. This request for verification also provides the U104 transaction database with information regarding the request, e.g., hospital identification, department identification, physician identification, patient identification, scan date, delivery information, etc.

Dataflow 3. The U104 transaction database sends a request for verification to the M2S Patient Evaluation And Management System (“PEMS”) component.

Dataflow 4. The M2S PEMS component sends a request for verification to the appropriate hospital coordinator. This request is sent via e-mail.

Dataflow 5. The hospital coordinator logs onto the M2S PEMS website component and verifies the study using standard https communication.

Dataflow 6. The M2S PEMS component advises the U104 transaction database that it has received appropriate verification from the hospital coordinator. The U104 transaction database notes this fact in its database.

Dataflow 7. The DAC 3 device, which is in communication (e.g., constant or periodic) with the U104 transaction database, looks for the requested verification in the U104 transaction database. Such verification is pulled from the U104 transaction database as a psql communication through a secure shell (ssh) tunnel.

Dataflow 8. If the DAC 3 device has received the requested verification from the U104 transaction database, the DAC 3 device “pushes” the 2D scan data (in encrypted form) to the M2S DICOM server through a secure shell (ssh) tunnel.

Dataflow 9. The 2D scan data is pulled from the DICOM server via the M2S downloading component.

Dataflow 10. The M2S downloading component sends processed 2D scan data to the M2S data repository and order confirmation information to the U104 Relational Database.

Dataflow 11. The M2S data repository sends the 2D scan data to the modeling processor, where the patient-specific 3D model is created.

Dataflow 12. The modeling processor sends the patient-specific 3D model (i.e., the study) back to the M2S data repository.

Dataflow 13. The M2S shipping component pulls the finished patient-specific 3D model from the M2S data repository.

Dataflow 14. The M2S shipping component queries the U104 transaction database for delivery information. Such delivery information includes, among other things, the “drop box” location on the ftp server (see below) where the patient-specific 3D model will be held for pick-up.

Dataflow 15. The U104 transaction database sends the appropriate delivery information to the M2S shipping component.

Dataflow 16. The M2S shipping component sends the patient-specific 3D model to the appropriate “drop box” location on the ftp server.

Dataflow 17. The DAC 3 device, which is in communication (e.g., constant or periodic) with the ftp server, looks for the patient-specific 3D model in the appropriate “drop box” location on the ftp server. The patient-specific 3D model is “pulled” from the ftp server to the DAC 3 device via an rsync communication.

Dataflow 18. The patient-specific 3D model is stored on the DAC 3 device until a user accesses it for viewing.

### (iii) Additional Details Re DAC 3 System Elements

DAC 3 Device

ssh Tunnels. ssh tunnels are established for webmin (-R), postgres (-L) and dicom (-L). These tunnels are initiated (and kept open) through the inittab mechanism. In one preferred configuration, the webmin tunnel is turned off, and only enabled by the remote site on request.

Crontab Scripts. Crontab scripts run on the DAC 3 device as two different users: the local DAC UNIX user (e.g., mmstest) and root.

With respect to the mmstest, which regulates the DAC 3 dialogue with the ftp server, the outgoing.sh procedure preferably operates 11 times an hour, pulling from FTP server, checking CHECKSUM, unpacking the data and updating the database element armorcar_outgoing.start_date and database element armorcar_outgoing.end_date. A database lock prevents multiple processes from interfering with each other. Furthermore, with respect to mmstest, the remove_preview.sh procedure calls delete_outgoing.pl, preferably once a day at midnight, and removes Preview® studies after 35 days (default condition). The actual expiration time is set in armorcars.expire_outgoing_studies.

With respect to root, which regulates the DAC 3 dialogue with the DICOM server, the incoming.sh procedure calls check_incoming.pl (preferably 2 times an hour, e.g., at “3 minutes” and “33 minutes”), checks /mms/incoming for new data, and updates the U104 armorcar_incoming_uids database element. The vsend.sh procedure, preferably operating every 5 minutes, uses send_image to do a DICOM send of a file to the DICOM server sorted by study_instance_uid. The remove_incoming.sh, preferably operating once a day at midnight, deletes studies from the DAC 3 device once they have been received by the DICOM server at M2S. The report_disk_usage.pl procedure, preferably running once every half hour, updates the amount of free space in the Preview® data SMB share.

The cron.daily procedure updates from ftp:/home/drop/dac_software into /mms/bin/scripts, /mms/bin/dicom and /var/spool/cron. This happens once a day via rsync.

Dicom Server (dicom.medicalmetrx.com)

simple_storage. DICOM Storage SCP from Mallinckrodt Institute of Radiology.

request_verfication.pl. This is the verification requesting script, and is preferably run once every 30 minutes. This element sends an email to the coordinator asking for verification after the DAC 3 device has received data. The “meta information” for this data in transferred to the U104 database and is utilized by PEMS.

mark_mms_received.pl. (every 5 minutes) When the Dicom Server has fully received the study after verification, this procedure sends an E-mail to the coordinator by looking for the files in /b/DICOM/incoming.

delete_incoming.pl. (10, 2, 6 and midnight every day)—Once a study has been marked “ready to model” (or cancelled), the 2D scan data is deleted from the server.

FTP (ftp.medicalmetrx.com)

virtual_mirror.pl. This procedure parcels ac_create output TGZ files into dropboxes based on when they were shipped, whether the DAC 3 device is actively responding (e.g., pulling) and the priority setting. The limit is currently set to 2 concurrent outgoing DAC 3 datasets.

keepitup.pl. This procedure preferably runs at 6:00 pm to ensure that the virtual_mirror process is running. This script uses “ps” to determine if the virtual_mirror job is alive or dead.

download_complete.pl. This procedure, preferably run every 10 minutes, emails the coordinator when the DAC has retrieved a Preview study (by asking the U104 transaction database).

delete_outgoing.pl. This procedure, preferably run everyday at midnight, deletes files that have been fully downloaded from both the dropbox and the dac_repository.

Postgresql Database (U104 Transaction Database)

mms_matrix. This is a database connection for the DAC 3 device which operates via a ssh tunnel through the DICOM server. The server scripts connect via the user dac_server.

DAC available views. The DAC available views are: armorcar_incoming (INSERT), armorcar_storage_space (UPDATE), armorcar_log_view (INSERT), armorcar_incoming_uids (SELECT, UPDATE), armorcar_outgoing (SELECT), armor_outgoing_updates (SELECT, UPDATE).

### (iv) Additional Details Re DAC 3 System Dataflow

Customer Sends DICOM Data To M2S Via DAC 3 Device

The CT technician sends data to the DAC 3 device by selecting the correct IP address, port and AE TITLE to access the DAC 3 device on the hospital's network.

The DAC 3 device notifies the mms_matrix database that it has received a CT scan for processing by writing a new row into the armorcar_incoming data file.

The request_verfication.pl procedure, which runs on the Dicom Server, sends an email to the appropriate hospital coordinator, requesting verification that the CT scan should be processed.

The hospital coordinator logs onto PEMS and verifies that the CT scan data should be processed, updating the ‘verified’ column in the armorcar_incoming data file. This action also creates a row in the armorcar_orders data file that associates a model number to the Study Instance UID of the incoming set of CT scan files.

The DAC 3 device sends the actual CT image data to M2S via the send_image (Mallinckrodt) program. This CT image data is received at the DICOM Server.

The mark_mms_received.pl procedure sets the armorcar_incoming.mms_received flag and emails the hospital coordinator.

M2S downloads the image files from the dicom:/b/DICOM/incoming data file and sets the “ready for modeling” status for the study.

The CT scan data is then processed (i.e., modeled).

The processed data is removed from the /b/DICOM/incoming by delete_incoming.pl data file.

Preview Data is “Pulled” Back to Hospital Institution Via the DAC 3 Device

The M2S Shipper runs the ac_create procedure on a Preview CD to complete the study fulfillment. This tars and compresses the Data directory into a TGZ file, which is secure copied to the FTP server at ftp:/home/drop/dac_repository.

The virtual_mirror procedure creates a hard link of the TGZ file into the appropriate dropbox.

The DAC 3 device polls the U104 database transaction database, preferably about 11 times an hour, to determine which studies have been completed and are available. If the DAC 3 device finds a study (i.e., completed model) in the dropbox, the DAC 3 device scp's the contents locally, verifies the checksum (md5sum) and unpacks the TGZ file to the /mms_preview SMB mount directory on the DAC 3 device.

Finally, the delete_outgoing.pl procedure runs on the FTP Server and removes downloaded studies.

### DAC 4

### Expanded System with Site-to-Site Transfer and Image Blinding Components

### (i) Overview

In the foregoing description, there is described a Digital Imaging and Communications Standards in Medicine (DICOM) device of the type made by M2S, Inc. of West Lebanon, N.H. (“M2S”). This device is sometimes referred to as “DAC 3”. The DAC 3 device is essentially a two-way transfer device comprising computer hardware and software for enabling the secure, cost-effective transmission of data through a firewall (e.g., a hospital firewall) and across the Internet, with an explicit order verification step.

The DAC 3 device is designed to allow the secure transfer of DICOM image data over regular Internet connections without using IPSec-based Virtual Private Networks (VPNs) such as those provided by Cisco Firewalls and VPN Client software. This minimizes the amount of software and setup required by the hospital IP staff. The DAC 3 device is preferably pre-configured to work on the hospital network behind the firewall, and contains all the software necessary to (i) send DICOM data across the firewall and through the Internet to M2S; and (ii) retrieve data (e.g., DICOM files, 3D patient-specific “studies”, CAD results, etc.) back through the Internet and across the firewall for use by medical professionals at the hospital. Note that while the DAC 3 system is designed to accommodate two-way transmission of medical data, some customers or sites may choose to utilize the DAC 3 system in an exclusively incoming, or outgoing, manner.

A key feature of the DAC 3 system is the ability for an individual at the hospital (e.g., a departmental coordinator, an imaging technologist, a study coordinator, etc.), hereinafter referred to as “the Coordinator”, to verify the image transmission before the image files are actually sent to M2S. This amounts to an order confirmation process and is implemented in the DAC 3 system through a “store and forward” strategy. Thus, in the preferred embodiment, the DAC 3 system acts as a DICOM Storage Class Provider (SCP) for the medical images. Additionally, the order confirmation lets the Coordinator add “meta” information about the images. This “meta” information may include Clinical Trial operational information (e.g., time point interval, patient code, etc.). In a typical Clinical Trial setting, this type of information is often communicated through the use of a Data Transfer Form (DTF). Furthermore, the “meta” information for the medical images may include demographic, observation and/or other clinical data about the patient that may subsequently be used as part of a patient Registry.

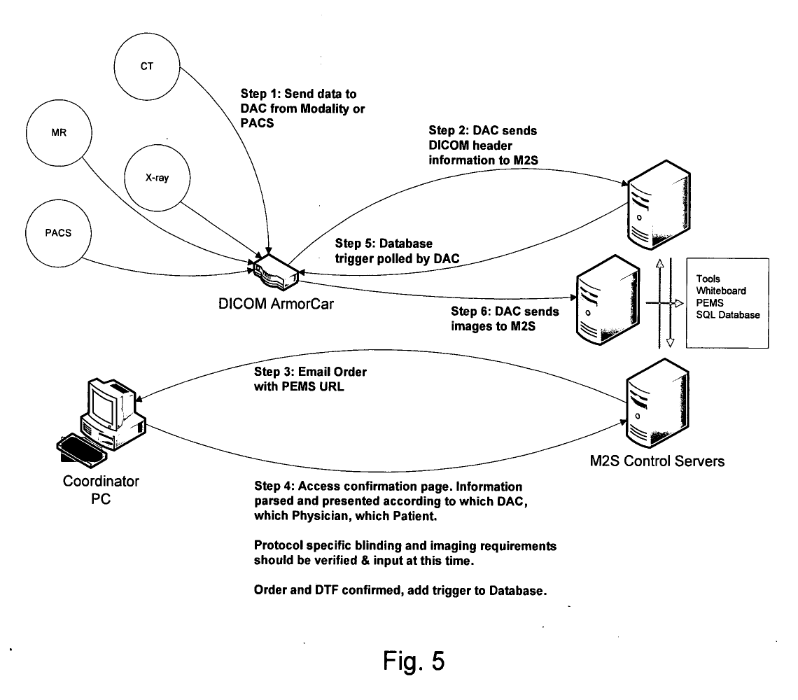

The steps involved in transferring an imaging study from a hospital site to M2S are illustrated in FIG. 5. First, in Step 1, an imaging scan of the subject is performed. Note that the DAC 3 system is compatible with any DICOM modality including X-ray, CT, MR, angiography, ultrasound, PET, etc. In Step 2, the DAC 3 system parses the DICOM headers from each of the received images and sends the associated patient/study/series information to the M2S database as a new “order”. This transaction initiates an email to the Coordinator responsible for a given DAC 3 system and provides a link back to the order confirmation page on the PEMS website (Step 3).

From the Coordinator's point of view, Step 4 is the most important part of this process and corresponds to “filling in” the paper Data Transfer Form (DTF) in the standard imaging corelab process flow—only in this case, the interface is through a web browser. In addition, since the DAC 3 system has access to information from the DICOM headers and the M2S database servers, many of the typical DTF fields can either be filled in automatically or checked against a pre-existing rule base. These DTF fields may include modality, number of images, number of series, study, series description, etc.

After the DAC 3 order has been confirmed by the Coordinator, a database trigger is enabled that is detected by the DAC 3 system in Step 5. The system then causes the imaging study to be transferred to the image servers at M2S.

In accordance with the present invention, in an expanded version of the DAC system, the system utilizes the same general configuration as the DAC 3 system discussed above. Significantly, however, the expanded version of the DAC system (which will sometimes hereinafter be referred to as the “DAC 4” system) adds both (i) a Site-to-Site (“S2S”) transfer component to the system, and (ii) a Coordinator-specified image header blinding component.

### (ii) Site-to-Site (S2S) Transfer

The DICOM ArmorCar 4 system (i.e., the DAC 4 system) introduces the concept of Site-to-Site (S2S) transfer, a system based on the DICOM ArmorCar 3 system (i.e., the DAC 3 system) and used for secure, encrypted, point-to-point transfers of medical imagery via M2S. The ArmorCar network is offered to customers who want to be able to do DICOM transfers from multiple sites to a single “collection point.” Potential customers would include other image-based service companies or medical device or pharmaceutical companies (e.g., clinical trial sponsors) who want to create their own image archive, and will be designed to work largely in a “pass-through” mode. Note that Coordinator verification may be made optional (through a database entry administered at M2S) with the addition of the Site-to-Site feature.

After initial Site-to-Site setup, no manual intervention (other than troubleshooting) should be required or expected, minimizing the amount of oversight required. For billing purposes, the DAC 4 servers count the number of received studies and received images, log the information to a database and report monthly numbers via the DAC Browser web interface. The accounting department may use this interface to generate monthly customer invoices.

In order to conform to patient privacy regulations, the capture of patient information, either intentionally or inadvertently through logging, should be minimized except for the purposes of customer reporting via the PEMS website. Any extraneous patient information visible at M2S in the DAC 4 systems should be deleted on a regular basis.

For each study sent to a receiving DAC 4 system, an email is sent to the receiving site. These emails establish an audit trail that the site can use to compare studies received against monthly invoices from M2S.

From the client point of view, the images must be sent from the source hospital reliably. In addition, the DAC 4 system must provide accessibility to the transmitted image files so that:
The Client can open the received files using eFilm and to be able to access them using Windows Explorer;
It is acceptable for the Client to receive studies organized as directories with <Study_Instance_UID> as the directory name; and
The Client also requests that a method be provided to “pre-parse” identifying tags from the DICOM headers so as to ease their work in organizing incoming image data on the DAC 4 system—one way to accomplish this is to include a README file listing the patient's name and DOB, institution, referring physician, scan date, study description, and additional patient data in the study directory described above.

### (iii) Site-to-Site Setup and Dataflow

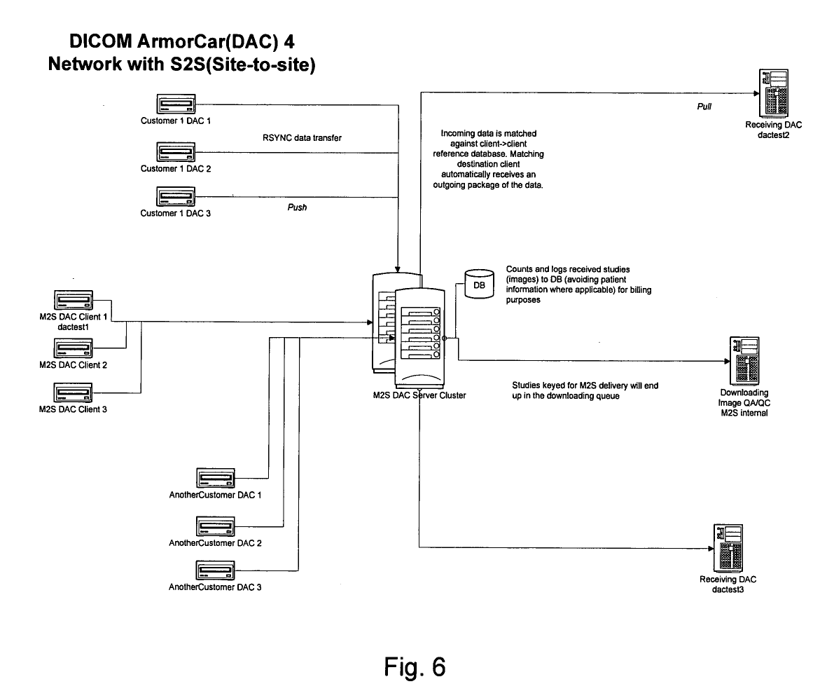

FIG. 6 illustrates how the Site-to-site transfer works. To simplify the discussion, DAC clients are shown on the left side of the illustration, while Receiving DAC's are shown on the right side of the illustration. In the actual implementation, any DAC can be a Site-to-Site sender or receiver (or both). Furthermore, in FIG. 6, there are also shown two different Site-to-Site networks, one for “Customer 1” and the other for “AnotherCustomer”, in addition to the M2S network used to support the DAC 4 system. Again, the DAC hardware in all these cases is the same and the actual sending/receiving relationships are configured through the following screens.

As an example, dactest1 can be configured to automatically forward DICOM images to both dactest2 and dactest3, in addition to providing data to the Image QA department at the M2S imaging corelab. In this case, dactest1 represents a DAC at a hospital site, while dactest2 could be a destination for image analysis and dactest3 is a separate destination controlled by a clinical trial sponsor.

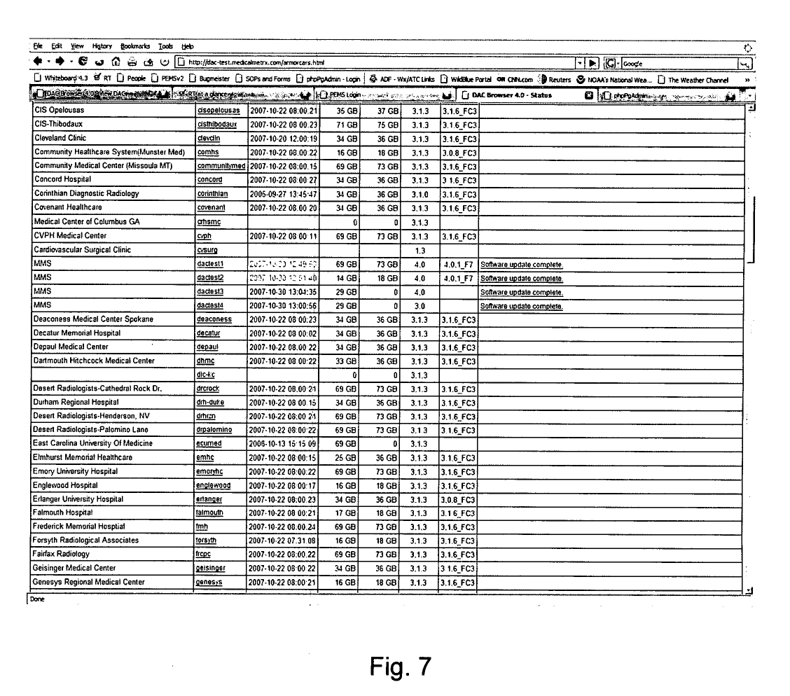

After each of the three DAC 4 units have been constructed and plugged into the network, they can be configured through the DAC Browser user interface shown in FIG. 7. The columns show Organization Name, DAC Name, Date/Time of Last Communication with the DAC, Free Storage Space, Total Storage Space, DAC Version, DAC OS Version and Last Log Message. The three DACs to be configured (i.e., are dactest1, dactest2 and dactest3) in the rows labeled “MMS” (which could also be labeled “M2S”) in the middle of the screen.

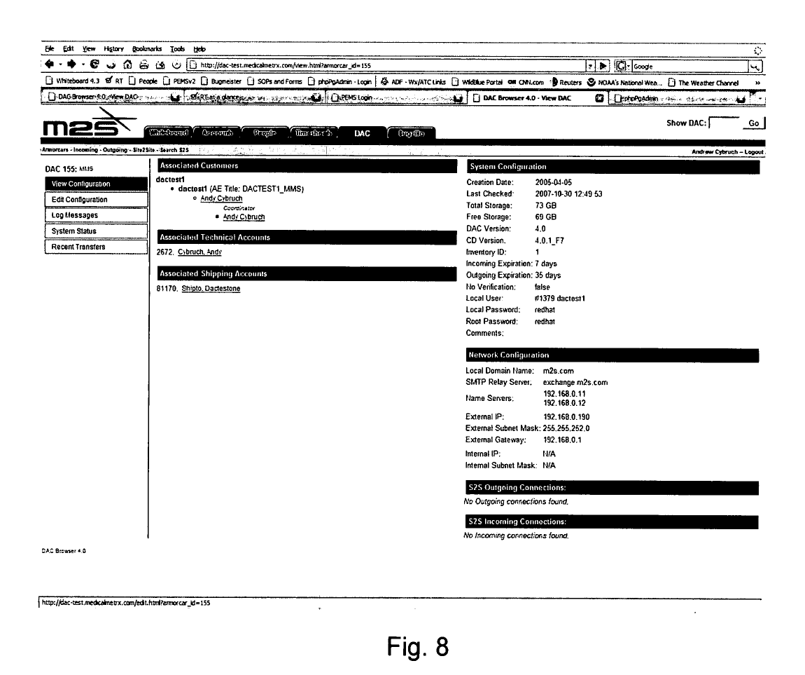

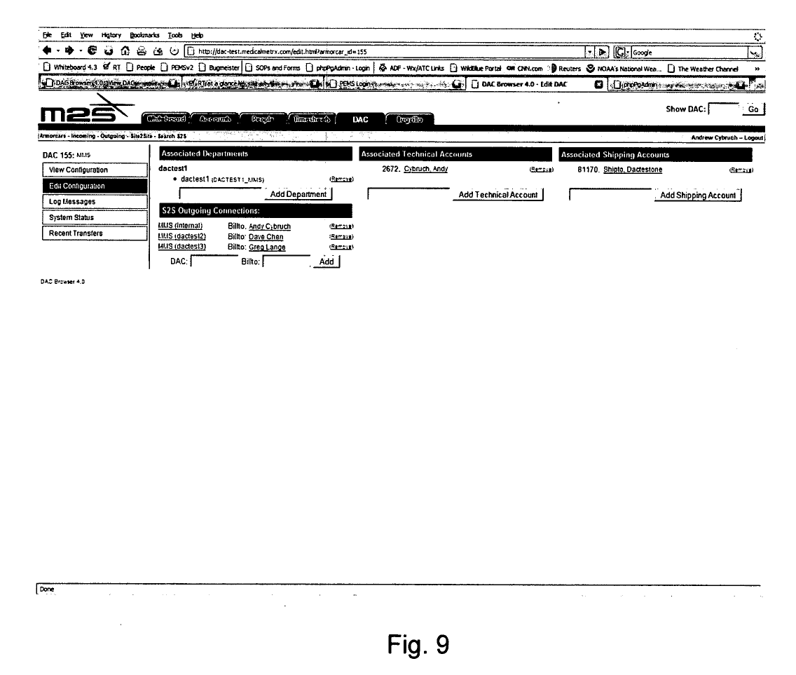

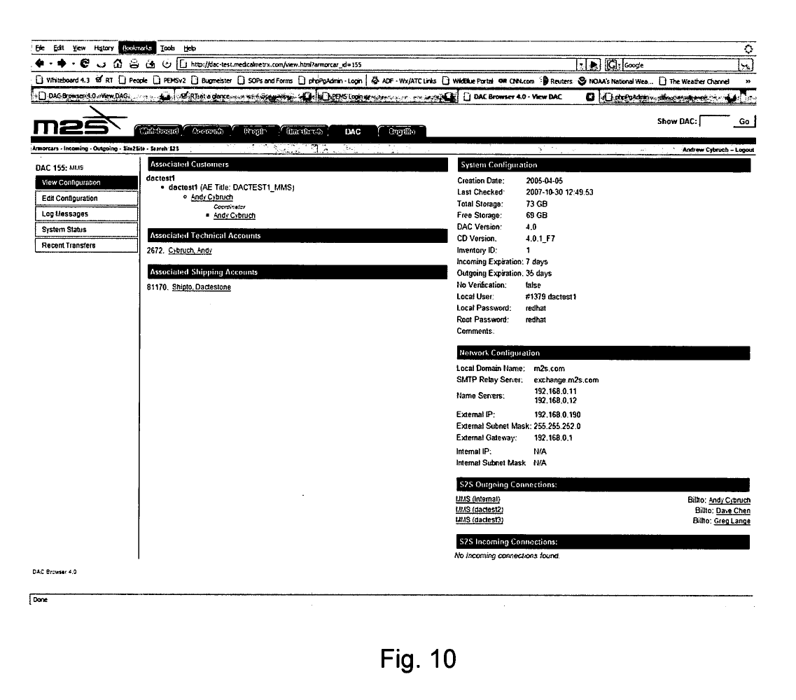

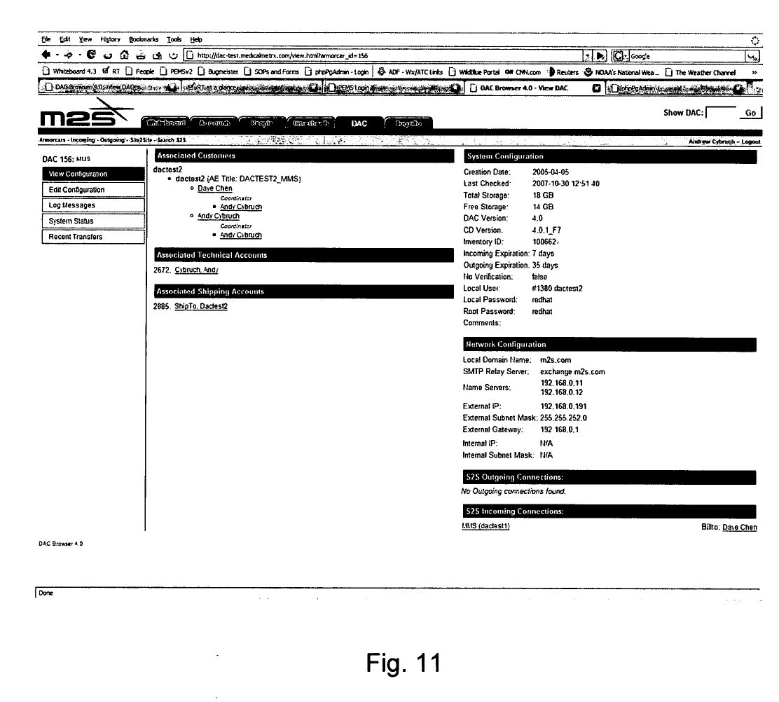

Clicking on the dactest1 link brings up the screen display shown in FIG. 8. In this example, the Coordinator for this DAC is “Andy Cybruch”. Note at the bottom right of the screen display that no Site-to-Site relationships have yet been defined. Now, clicking on the Edit Configuration tab on the left of the screen brings up the screen display shown in FIG. 9. Here the three outgoing Site-to-Site connections have been made to dactest2, dactest3 and the M2S imaging corelab (an internal connection). Note that the DAC destination and billing can be assigned separately in this case. By going back to the View Configuration screen shown in FIG. 10, the three new Site-to-Site Outgoing Connections made for dactest1 can be confirmed in the bottom right portion of the screen. FIG. 11 shows the configuration for dactest2 and the new Site-to-Site Incoming connection from dactest1.

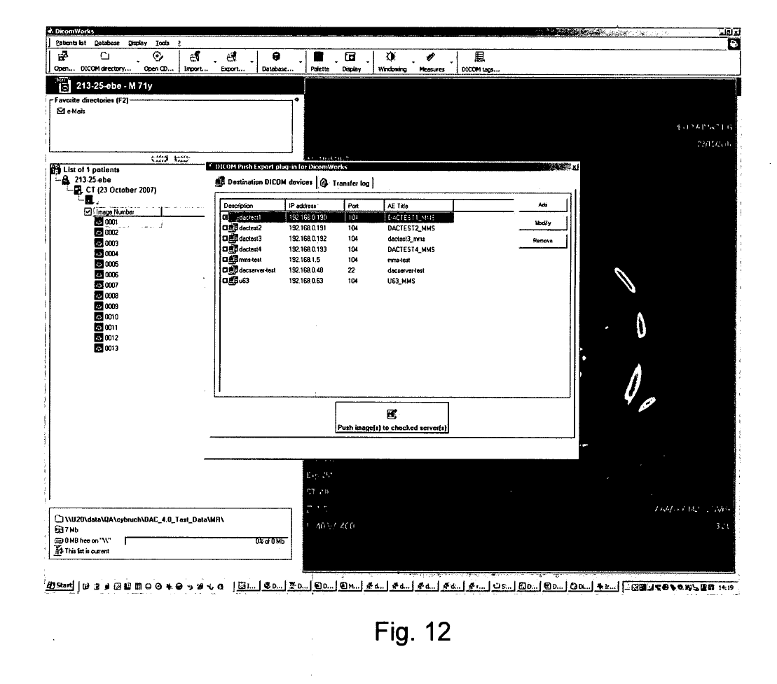

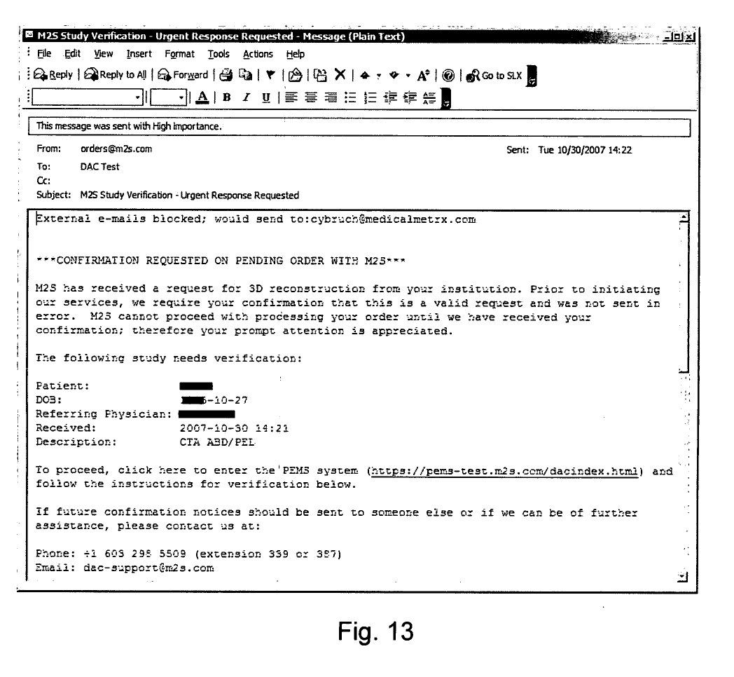

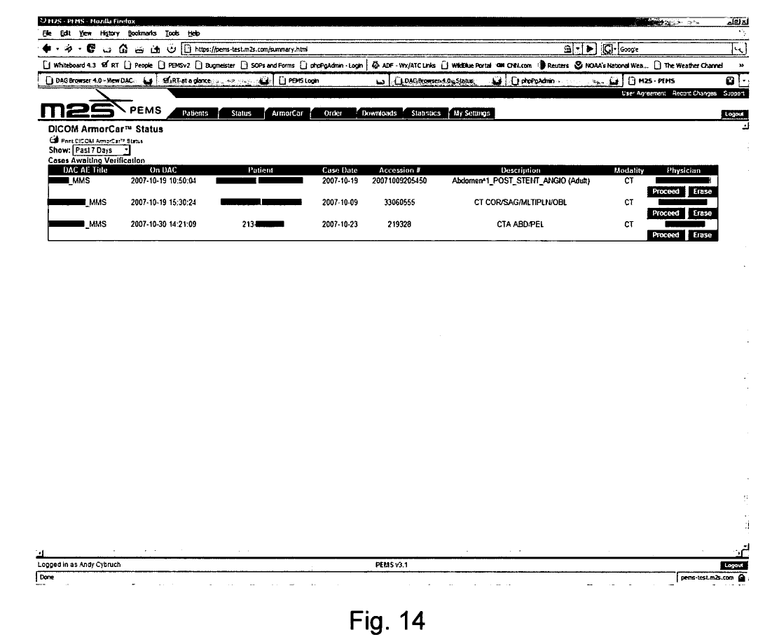

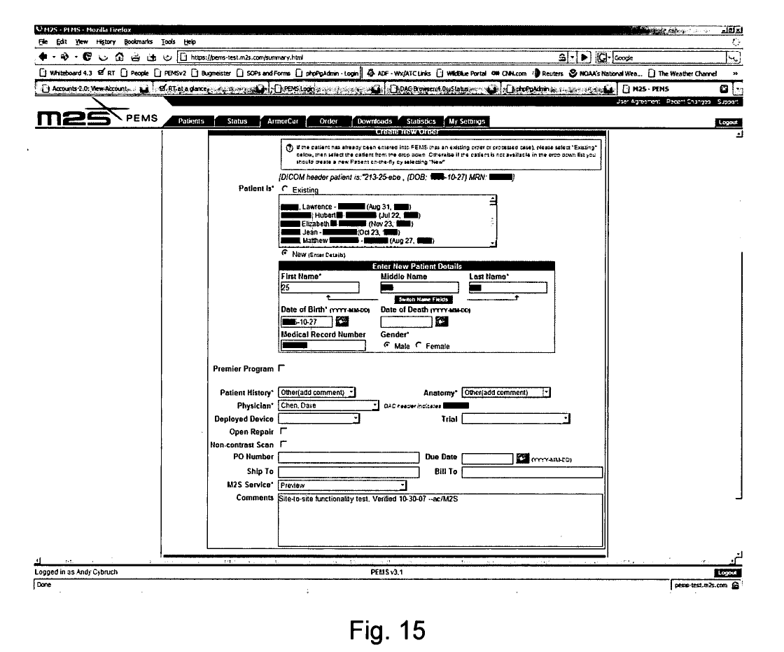

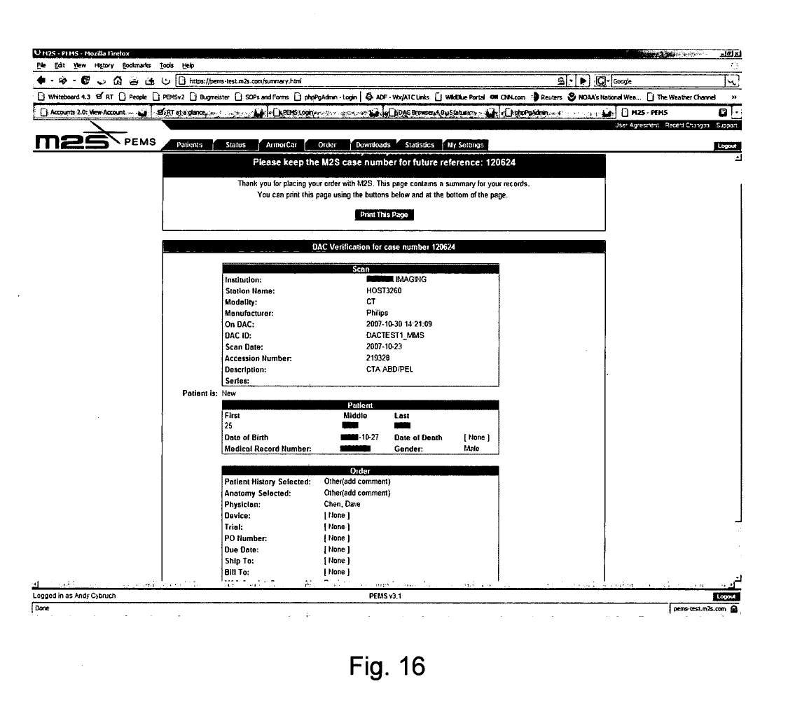

To test the new Site-to-Site configuration, a DicomWorks tool can be used to open a CT series, e.g., as shown in FIG. 12. This series includes 13 images for subject 231-25-ebe. In the Export dialog, dactest1 is selected as the destination DICOM device. After the send is effected, the email shown in FIG. 13 is sent to the Coordinator for dactest1 (in this case “Andy Cybruch”). The URL enclosed in the email redirects the user to the screen display shown in FIG. 14 at the PEMS website. The Coordinator can then see, in the third row, that dactest1 has received a CT series for patient 213-25-ebe on Oct. 30, 2007 at 2:21 in the afternoon. Clicking Proceed then links the user to the DAC Order Page shown in FIG. 15.

The DAC Order Page is the primary point of communication for a study Coordinator at the hospital. This screen (FIG. 15) is used to identify the patient, select the Physician for this patient and, if appropriate, to select a particular interval for a Clinical Trial that this imaging timepoint represents. Note that depending on the requirements of a particular clinical trial, the data collection requirements may be variable. After the DICOM header information has been confirmed and the required extra data fields have been entered, an Order Number is generated (in this case 120624) and a printable Verification screen is presented to the Coordinator.

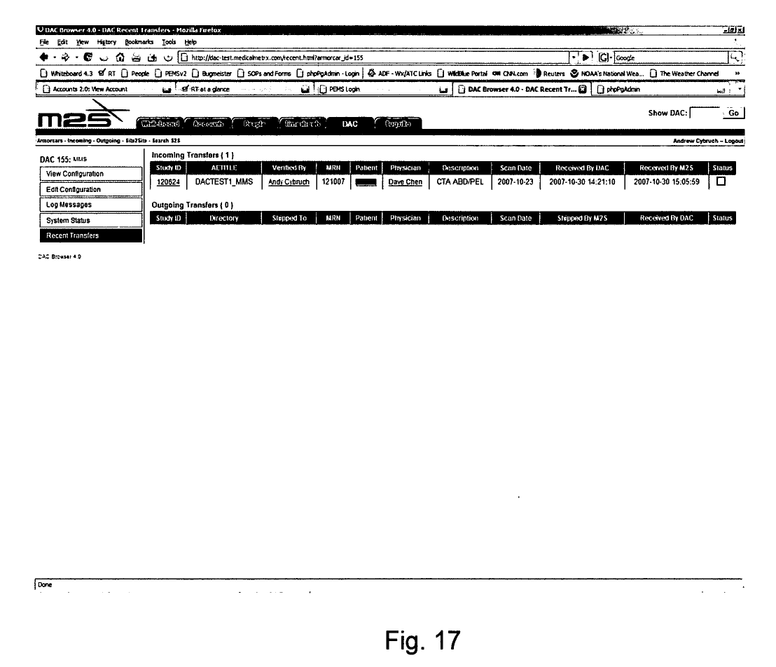

After DAC Verification is complete, dactest1 is finally allowed to transfer the 13 CT images from the hospital site to the M2S DAC Server (via an ssh tunneled rsync call). The details of this Incoming Transfer can be confirmed by looking at the Recent Transfers tab for dactest1 in the DAC Browser, as shown in FIG. 17. In this section, there can be seen the name of the person who verified this DAC order, the name of the patient and physician, and date/time stamps for when the medical images were first received by the DAC and then subsequently received by the DAC Server.

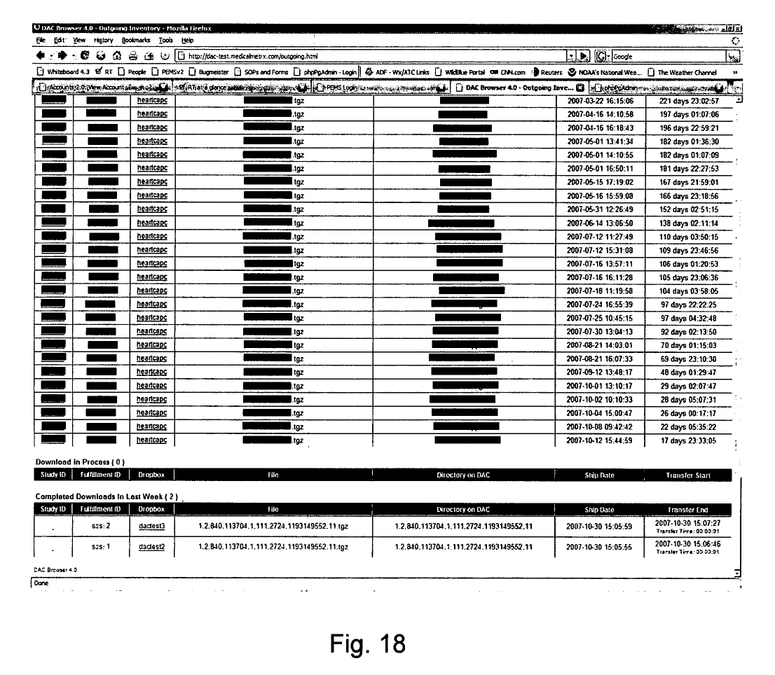

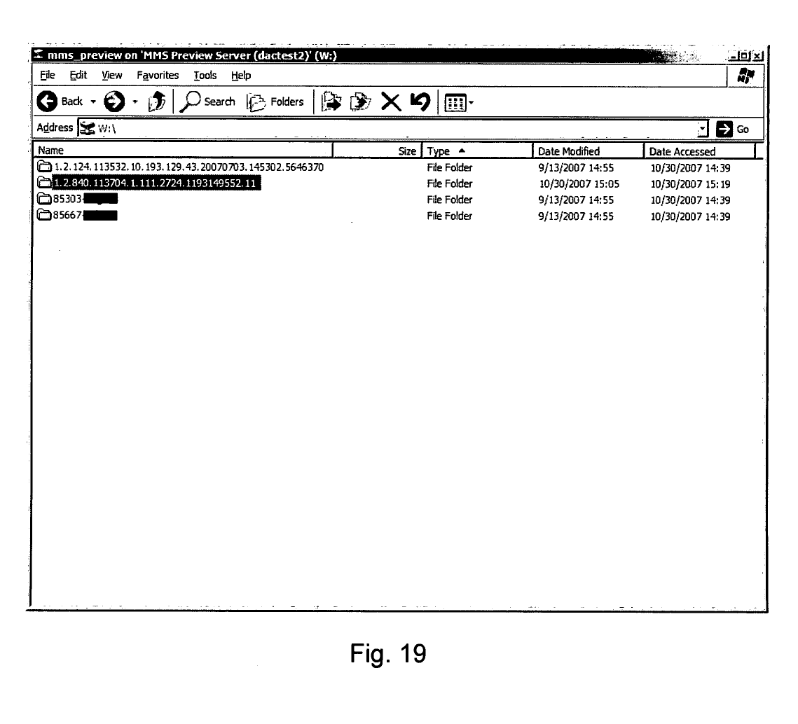

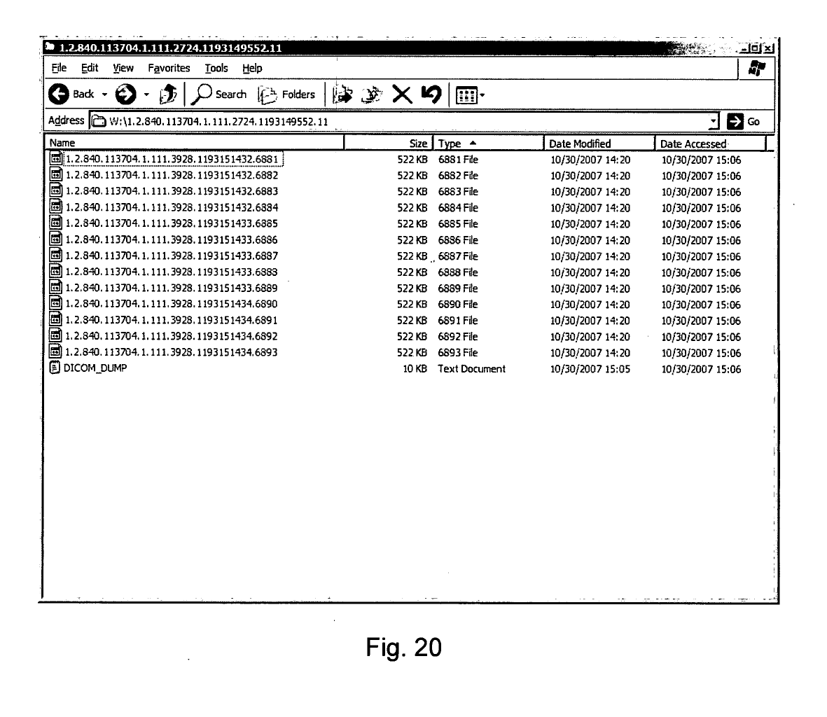

Finally, to confirm the Site-to-Site behavior, the Outgoing Inventory page of the DAC Browser (FIG. 18) can be consulted. Note in the Completed Downloads section the two rows for dactest2 and dactest3 generated by the original transfer of the 13 CT images to dactest1. As expected, the ship date is just after the study was received by M2S, as shown in the second-to-last column of FIG. 17. To access the outgoing images and studies, each DAC supports a Windows share through the SMB protocol. FIG. 19 shows a Windows mount of dactest2 and the data that is available in the outgoing folder. The selection is for the Study UID 1.2.840.113704.1.111.2724.1193149552.11 first seen in the Downloads section of FIG. 18. FIG. 20 is a detail for the contents of the Study UID folder and shows the 13 CT images in addition to a DICOM_DUMP file that describes the image contents in some detail.

### (iv) Image Anonymization “On the Fly”

### Coordinator-Specified Image Header Blinding Component

The “store and forward” architecture of the DICOM ArmorCar system provides the ability to modify the medical image DICOM headers before they are sent to the M2S imaging corelab or to other Receiving DACs in the Site-to-Site setup described in the preceding section. This feature is used to support Patient Anonymization (or Pseudononymization) for patients that are subjects in a clinical trial. Because of patient privacy concerns, it is the ultimate responsibility of a hospital site to blind patient identifiers from medical images used for research and shared with third parties. This responsibility is usually covered in the Informed Consent that is obtained from the patient.

In the United States, it has been acceptable for a hospital site to rely on an imaging corelab to provide patient name-blinding as part of its service. However, in some other countries, or because of local IRB restrictions regarding patient confidentially, this method may not be acceptable. In practice, these hospital sites must then use whatever collection of tools may be available to modify the DICOM data before it is sent to the imaging corelab. This approach for patient name-blinding is generally inconvenient and cumbersome, sometimes inaccurate, and often incompletely audited by the site. In addition, it adds a legal risk to the hospital site in case patient identifiers are inadvertently released to the third party.

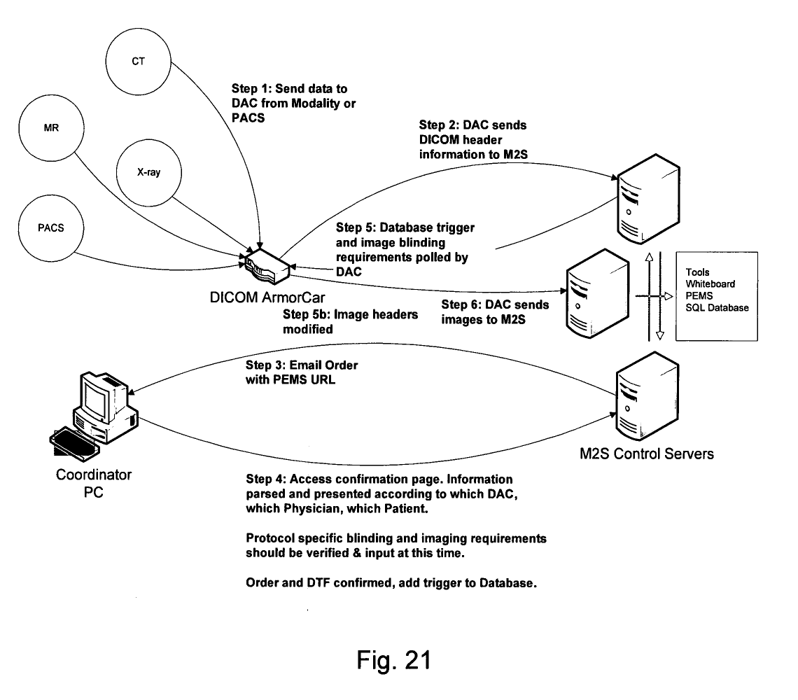

Referring now to FIG. 21, it will be seen that the patient name-blinding requirements can be specified at Step 4 by the Coordinator through the DAC

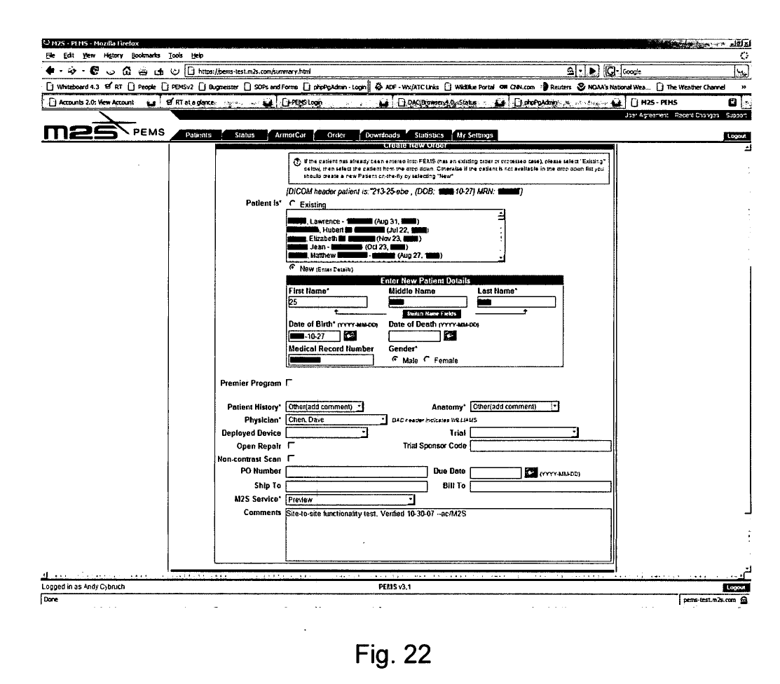

Order page. The Subject Code specified by the Coordinator (FIG. 22) can have “validation rules” specified by the trial sponsor that force the proper format before the DAC Order is accepted. Additionally, the Trial Sponsor Code (FIG. 22) can be made a required input field. After a DAC Order is placed, the printable DAC Verification page is changed so as to present a log of the DICOM header tags that are changed with a comparison of new values and original values. Note that this log information is kept at the hospital site and is not transmitted back to the imaging corelab.

The DAC 4 system then retrieves the image header blinding requirements along with the database trigger at Step 5. Referring again to FIG. 21, a new Step 5b has been added for modifying the DICOM image header before the images are sent to M2S at Step 6.

To actually perform the header modifications, a program such as merge_tools, developed internally at M2S from the MergeCom Toolkit, can be used.

[dchen@u63 bin]$ ./merge_tools
M2S Dicom manipulation tools.
Usage: mergetools IN_FILE [-o|--outfile OUT_FILE] [-s|--search TAG]

| | [-r\|--remove TAG] [-e\|--edit TAG VALUE] [-cp\|--clean-priv] |
|---|---|
| | [-cs\|--clean-seq] [-ce\|--convert-to-explicit-le] |
| | [-c\|--config CONFIG] [-l\|--log-file LOG_FILE] |
| | [-ll\|--log-level LOG_LEVEL] [-lt\|--log-trace LOG_TRACE] |
| | [-lb\|--num-backup-log-files NUM_LOGS] |
| where: | |
| IN_FILE | Name (and path) of source file |
| OUT_FILE | Name of output file different than the input file. |
| TAG | DICOM tag in hex format (ex. 00100010) to be dealt with. |
| VALUE | The new value for the tag, in quotes. |
| | Reasonable conversion will occur. |
| CONFIG | The full path of the main configuration file |
| | (The default is ‘built-in configuration’) |
| LOG_FILE | The full path of the log file |
| | (The default is defined in the main configuration file) |
| LOG_LEVEL | ERROR (only errors), WARNING (erros and warnings) or INFO |
| | (all) |
| | (The default is defined in the main configuration file) |
| LOG_TRACE | None, one or more of T2, T3, T4, T5, T6, T7, T8, T9 |
| | (The default is defined in the main configuration file) |
| NUM_LOGS | The maximum number of historical log files |
| | (The default is defined in the main configuration file) |

The merge_tools program takes a Part 10 DICOM file as input and a series of arguments to specify the TAGS to modify, the new values and the name of the output file.

```
./merge_tools $inFile \
    --edit 00100010 “BigPharma_Trial_1\hat{ }001-1234” \
    --edit 00100020 “1234” \
    --edit 00080050 “120624” \
    --outfile /var/tmp/_out.dcm”
```

In a typical blinding sequence, the Patient Name is replaced by an identifier for the Clinical Trial and patient Subject Code. The hospital MRN is replaced with an M2S allocated id number (1234) and the Study Accession number is replaced with an M2S generated order ID from the DAC Confirmation process (120624). Other more restrictive blinding profiles may require that all DICOM Private tags be removed (with the -clean-priv argument), or other Patient or Study level tags be removed (with the -remove argument).

In general, there is a tradeoff between the amount of data removed at the Hospital Site and the ability to do downstream image reconciliation later at the imaging corelab. For this reason, it is important for the Hospital Site to obtain a printable log, such as is shown in FIG. 22, which lists the modified fields with both the new and old values.

### Further Modifications

It will be understood that many changes in the details, materials, steps and arrangements of elements, which have been herein described and illustrated in order to explain the nature of the invention, may be made by those skilled in the art without departing from the scope of the present invention.

What is claimed is:

1. An agent for transmitting data between a first site and a second site, and between the first site and a third site, wherein the first site, the second site and the third site are connected to the Internet, and further wherein the first site is located behind a firewall;
the agent being located behind the firewall and being connected to the first site and to the Internet, the agent comprising first, second, third and fourth components;
the first component being configured for receiving raw data from the first site;
the second component being configured for pushing a verification query through the firewall and over the Internet to the second site;
the third component being configured for pulling a verification over the Internet and through the firewall from the second site; and
the fourth component being configured for, upon receipt of the verification, pushing the raw data through the firewall and over the Internet to the second site and the third site.

2. An agent according to claim 1 wherein the agent further comprises a fifth component, the fifth component being configured for pulling processed data over the Internet and through the firewall from the second site and for holding the pulled processed data for access by the first site.

3. An agent according to claim 1 wherein the first component is configured to receive scan data from the first site.

4. An agent according to claim 1 wherein the second component is configured so that the verification query includes information about the raw data received by the first component from the first site.

5. An agent according to claim 1 wherein the first component is configured to receive scan data from the first site, and the second component is configured so that the verification query includes information about the scan data received by the first component from the first site.

6. An agent according to claim 1 wherein the second component is configured to push the verification query using psql via an ssh tunnel.

7. An agent according to claim 1 wherein the third component is configured to pull the verification using psql via an ssh tunnel.

8. An agent according to claim 1 wherein the fourth component is configured to push DICOM data through the firewall and over the Internet to the second site and the third site.

9. An agent according to claim 2 wherein the fifth component is configured to pull non-DICOM data over the Internet and through the firewall.

10. An agent according to claim 2 wherein the fifth component is configured to pull DICOM data over the Internet and through the firewall.

11. An agent according to claim 1 wherein the raw data is pushed using an ssh tunnel.

12. An agent according to claim 2 wherein the processed data is pulled using an ssh tunnel.

13. An agent according to claim 1 wherein the raw data is pushed using either an rsync or scp protocol.

14. An agent according to claim 2 wherein the processed data is pulled using either an rsync or scp protocol.

15. An agent according to claim 1 wherein the raw data is encrypted prior to pushing through the firewall.

16. An agent according to claim 2 wherein the processed data is decrypted after pulling through the firewall.

17. An agent according to claim 1 wherein the raw data is compressed prior to pushing through the firewall.

18. An agent according to claim 2 wherein the processed data is decompressed after pulling through the firewall.

19. An agent according to claim 2 wherein the fourth component is configured to anonymize the raw data prior to pushing the raw data through the firewall and over the Internet to the second site and the third site.

20. An agent for transmitting data between a first site and a second site, wherein the first site and the second site are connected to the Internet, and further wherein the first site is located behind a firewall;
the agent being located behind the firewall and being connected to the first site and to the Internet, the agent comprising first, second, third and fourth components;
the first component being configured for receiving raw data from the first site;
the second component being configured for pushing a verification query through the firewall and over the Internet to the second site;
the third component being configured for pulling a verification over the Internet and through the firewall from the second site; and
the fourth component being configured for, upon receipt of the verification, pushing the raw data through the firewall and over the Internet to the second site;
and further wherein the fourth component is configured to anonymize the raw data prior to pushing the raw data through the firewall and over the Internet to the second site.

21. An agent according to claim 20 wherein the fourth component is configured to push the raw data through the firewall and over the Internet to a third site upon receipt of the verification.

22. A system comprising:
a first site, a second site and a third site, wherein the first site, the second site and the third site are connected to the Internet, and further wherein the first site is located behind a firewall;
an agent for transmitting data between the first site, the second site and the third site, the agent being located behind the firewall and being connected to the first site and to the Internet, the agent comprising first, second, third and fourth components;
the first component being configured for receiving raw data from the first site;
the second component being configured for pushing a verification query through the firewall and over the Internet to the second site;
the third component being configured for pulling a verification over the Internet and through the firewall from the second site; and
the fourth component being configured for, upon receipt of the verification, pushing the raw data through the firewall and over the Internet to the second site and the third site.

23. A system according to claim 22 wherein the agent further comprises a fifth component, the fifth component being configured for pulling processed data over the Internet and through the firewall from the second site and for holding the pulled processed data for access by the first site.

24. A system according to claim 22 wherein the fourth component is configured to anonymize the raw data prior to pushing the raw data through the firewall and over the Internet to the second site and the third site.

25. A system comprising:
a first site and a second site, wherein the first site and the second site are connected to the Internet, and further wherein the first site is located behind a firewall;
an agent for transmitting data between the first site and the second site, the agent being located behind the firewall and being connected to the first site and to the Internet, the agent comprising first, second, third and fourth components;
the first component being configured for receiving raw data from the first site;
the second component being configured for pushing a verification query through the firewall and over the Internet to the second site;
the third component being configured for pulling a verification over the Internet and through the firewall from the second site; and
the fourth component being configured for, upon receipt of the verification, pushing the raw data through the firewall and over the Internet to the second site;
and further wherein the fourth component is configured to anonymize the raw data prior to pushing the raw data through the firewall and over the Internet to the second site.

26. An agent according to claim 25 wherein the fourth component is configured to push the raw data through the firewall and over the Internet to a third site upon receipt of the verification.

27. A method for transmitting data between a first site and a second site, and between the first site and a third site, wherein the first site, the second site and the third site are connected to the Internet, and further wherein the first site is located behind a firewall, comprising:
receiving data from the first site;
pushing a verification query through the firewall and over the Internet to the second site;
pulling a verification over the Internet and through the firewall from the second site; and
upon receipt of the verification, pushing data through the firewall and over the Internet to the second site and the third site.

28. A method according to claim 27 wherein the method comprises the further step of pulling data over the Internet and through the firewall from the second site and for holding the pulled data for access by the first site.

29. A method according to claim 27 wherein the data is anonymized prior to pushing the data through the firewall and over the Internet to the second site and the third site.

30. A method for transmitting data between a first site and a second site, wherein the first site and the second site are connected to the Internet, and further wherein the first site is located behind a firewall, comprising:
receiving data from the first site;
pushing a verification query through the firewall and over the Internet to the second site;
pulling a verification over the Internet and through the firewall from the second site; and
upon receipt of the verification, anonymizing the data and then pushing the data through the firewall and over the Internet to the second site.

31. A method according to claim 30 wherein the anonymized data is pushed through the firewall and over the Internet to a third site upon receipt of the verification.
